(19) United States
(12) Patent Application Publication
(10) Pub. No.: US 2015/0222062 A1
(43) Pub. Date: Aug. 6, 2015

(54) DUAL COAXIAL CABLE-TO-BOARD CONNECTOR

(71) Applicant: Apple Inc., Cupertino, CA (US)

(72) Inventor: Jason Sloey, Cedar Park, TX (US)

(73) Assignee: Apple Inc., Cupertino, CA (US)

(21) Appl. No.: 14/687,899

(22) Filed: Apr. 15, 2015

Related U.S. Application Data
(60) Provisional application No. 61/980,518, filed on Apr. 16, 2014.
(60) Provisional application No. 61/987,392, filed on May 1, 2014.

(51) Int. Cl. H01R 24/40; H01R 13/6581

(52) U.S. Cl. CPC H01R 24/40; H01R 13/6581; H01R 2103/00

(57) ABSTRACT

Coaxial cable connector systems including connector plugs and receptacles that consume a reduced amount of board space and are readily connected together. One example may provide coaxial connector plugs and receptacles that may be used to connect more than one coaxial cable. Another example may provide a connector system where a plug may rotate relative to the receptacle in order to simplify forming a connection. Another example may provide a connector system having a locking mechanism. These connector systems may provide connections for one, two, or more coaxial cables.

### CROSS REFERENCE TO RELATED APPLICATIONS

The present application claims the benefit of U.S. provisional application Nos. 61/980,518, filed Apr. 16, 2014, and 61/987,392, filed May 1, 2014, which are incorporated by reference.

### BACKGROUND

The number of types of electronic devices that are commercially available has increased tremendously the past few years and the rate of introduction of new devices shows no signs of abating. Devices, such as tablet, laptop, netbook, desktop, and all-in-one computers, cell, smart, and media phones, storage devices, portable media players, navigation systems, monitors, and others, have become ubiquitous.

The functionality of these devices has likewise greatly increased. This in turn has led to increased complexity inside of these electronic devices. For example, several types of boards, such as flexible circuit boards, printed circuit boards, and others, are often included in a single device. Signals may be routed from one of these boards to another using various types of cables or interconnect, such as coaxial cables.

Coaxial cables may include a shielded conductor terminating at each end in a connector insert or plug. The connector plug at each end of the cable may be inserted into a receptacle that may be mounted on a printed circuit board. Signals may then be conveyed from a first receptacle on a first board, through a coaxial cable to a second receptacle, which may be located on the first or a second board. In this way a first circuit may communicate with a second circuit in an electronic device.

But these connectors may consume a large amount of board space. That is, each receptacle has a footprint of its own that may consume an area on a board. Also, each coaxial receptacle may need a certain amount of space between itself and other coaxial receptacles and devices.

Connections may be made using these connectors during device assembly. If a connection is difficult to form, it may slow the assembly process, increase costs, and increase the amount of rework that may need to be done. For this reason, it may be desirable for the connection to be simple to make.

Thus, what is needed are coaxial cable connector systems including connector plugs or inserts and receptacles that consume a reduced amount of board space and are readily connected together.

### SUMMARY

Accordingly, embodiments of the present invention may provide coaxial cable connector systems, including connector plugs or inserts and receptacles, that consume a reduced amount of board space and are readily connected together. An illustrative embodiment of the present invention may provide coaxial connector plugs and receptacles that may be used to connect more than one coaxial cable. Providing a connector plug and receptacle for two or more coaxial cables may allow for the consolidation of multiple receptacles into a single unit. This consolidation may allow the simplification of connector structures such that a single receptacle for N coaxial cables may be smaller than N individual receptacles. Also, since N connectors are able to be consolidated, there is no requirement for space to be provided between the N connector receptacles, wherein N may be 2, 3, or more. These factors may combine to provide coaxial connector plugs and receptacles that may reduce an amount of board area consumed.

In these embodiments of the present invention, a coaxial connector system may provide a connection for two coaxial cables, though in other embodiments of the present invention, coaxial connector systems, including plugs and receptacles, for three, four, or more coaxial cables may be provided.

Another illustrative embodiment of the present invention may provide a coaxial connector system where a connection between a plug and a receptacle is readily formed. In various embodiments of the present invention, this may be accomplished by providing a plug and receptacle where the plug may rotate relative to the receptacle during insertion and while the plug is inserted into the receptacle. These rotatable connector systems may provide connections for one or more coaxial cables. For example, these rotatable connector systems may provide connections for one or two coaxial cables, though embodiments may provide connector systems for three, four, or more coaxial cables.

In various embodiments of the present invention, the plug may be rotatable relative to the receptacle in various ways. In some embodiments of the present invention, a receptacle may sit flat on a printed circuit board or other appropriate substrate. The direction or axis of connection may be orthogonal to the printed circuit board. The cable may enter the plug in a direction that is parallel to the printed circuit board. The plug may be rotatable such that the cable may move in a plane parallel to the printed circuit board. This may simplify connection of the plug to the receptacle since the cable does not need to approach the receptacle along a specific line. Instead, a connection may be formed so long as the cable approaches the receptacle in at least a part of the plane that is parallel to the printed circuit board or other appropriate substrate. This may make it easier to route a cable and to form a connection during assembly. This simplification of the assembly process may help to reduce costs and reduce the number of assembled devices that need to be reworked.

In an illustrative embodiment of the present invention where a rotatable connector system forms a connection for a single coaxial cable, the plug may be free to rotate completely around the receptacle. That is, the plug may be free to rotate 360 degrees around the receptacle. This may allow a connection to be made so long as the cable approaches the receptacle in the plane that is parallel to the printed circuit board on which the receptacle resides.

In an illustrative embodiment of the present invention where a rotatable connector system forms a connection for more than one coaxial cable, the amount that the plug may rotate during and after insertion relative to the receptacle may be limited. That is, during insertion, a connection may be formed so long as the plug is within a certain angular range. After insertion, this may allow the plug to rotate such that the cable sweeps through the angular range. In practice, this limitation may still allow enough flexibility during assembly that a connection may be readily made. That is because a connection may be formed so long as the cable approaches the receptacle in at least a part of the plane that is parallel to the printed circuit board on which the receptacle resides. This limitation may arise primarily because of the existence of multiple contacts in the plug and receptacle.

In one embodiment of the present invention, the amount of rotation may be limited to prevent one contact in the plug from connecting to more than one contact in the receptacle. In one such embodiment, contacts for the plug and receptacle may be located along a ring. As the plug and its contacts rotate relative to the receptacle and its contacts, one plug contact may engage more than one receptacle contact. Accordingly, a stop feature may be included to prevent this degree of rotation.

Similarly, in another embodiment of the present invention, a plug contact may be rotated sufficiently such that it loses contact with its corresponding receptacle contact. Again, a stop may be used to prevent this degree of rotation.

In various embodiments of the present invention, the acceptable rotation may be increased by increasing a size of the plug and receptacle contacts such that the plug contacts do not lose contact with corresponding receptacle contacts during rotation. This increase in size may be limited by the need to reduce cross talk between contacts in the plug and between contacts in the receptacle. To further reduce cross talk, one or more ground planes may be located between contacts on the plug, between contacts on the receptacle, or between both sets of contacts.

In still other embodiments of the present invention, contacts in the plug and in the receptacle may be placed on concentric rings. While this may allow the freedom of complete rotation, it may dramatically increase the size of the connector system.

In various embodiments of the present invention, the amount of permissible rotation of a plug relative to a receptacle may be limited in a number of ways. Again, a stop may be used. This stop may be formed by a partial ring on the plug and a raised portion on the receptacle, though in other embodiments of the present invention, this configuration may be reversed or other structures may be used. More specifically, a plug may have a shield portion that forms a portion of a circle. The receptacle may include a raised portion that fits in the open portion of the shield circle when the plug is inserted in the receptacle. The plug is then free to rotate until the raised portion on the receptacle encounters an end of the open portion of the shield ring. This combination of features may further provide a keying function for the plug and receptacle since the plug may only be inserted in the receptacle when the raised portion of the receptacle is in the open portion of the plug shield ring. These stop features may define angular range wherein a plug may be inserted into a receptacle.

In the above embodiments of the present invention, a housing of a plug may mate with a housing of a receptacle and be held in place by a lip of a shield ring on the plug engaging a slot or indentation on a corresponding ring on the receptacle. In these embodiments of the present invention, a plug may be pushed onto the receptacle until the plug's shield ring lip engages the slot or indentation on the receptacle. Also, when the plug is pushed onto the receptacle, the plug contacts may deflect around a raised portion of the receptacle to engage contacts on the raised portion. The plug contacts may exert a lateral force in a direction orthogonal to a direction of insertion. (With this configuration, the plug contacts may not exert a force pushing the plug away from the receptacle in a direction of a disconnection, thereby reducing the chance of an accidental disconnection.) Accordingly, during insertion, enough force may be applied until the plug's shield ring lip engages the slot or indentation on the receptacle and the contacts engage the receptacle's raised portion. The force applied in these embodiments may be directly related to a holding force of the plug in the receptacle. That is, the more force required to insert the plug, the stronger the holding force may be.

In these embodiments, since the plug is pushed onto the receptacle, damage may occur if excessive force is used or if the plug is pushed onto the receptacle in an offset direction. Accordingly, other embodiments of the present invention may provide a locking mechanism to secure a plug in place when coupled to a receptacle. This locking mechanism may allow an insertion of a plug into a receptacle with a low force while providing a strong retention force. As compared to the above embodiments of the present invention, the hold force of the plug in the receptacle is decoupled or separated from the insertion force needed to insert the plug into the receptacle. The plug may also have a distinct position when locked to the receptacle. This may be visually used during device assembly to ensure that the plug is engaged with the receptacle. The locking mechanism may also provide further protection from inadvertent disconnects when the electronic device is subjected to external forces.

An illustrative embodiment of the present may provide a plug and receptacle for forming conductive paths between one, two, three, or more coaxial cables and a board. The plug may have tabs that fit in openings in a housing in a connector receptacle at the beginning of an insertion. The openings may include ramp portions, in which the tabs may travel as the plug is further inserted. The insertion force needed to insert the plug into the receptacle may be adjusted by adjusting a slope of the ramp. The travel of the tabs down the ramp may cause a housing of the plug to rotate, or more specifically, during assembly, the housing may be rotated such that the tabs travel down the ramps. With further rotation, the tabs may reach a notched portion of the opening. The tabs may be secured in place when they reach the notched portion such that the chance of an inadvertent disconnection is reduced. To further secure the tabs in place, a force in the direction of disconnection may be applied to the plug. This force may be generated by sloped portions of shields on either or both the plug and receptacle. The force may be generated by a sloped edge of the raised portion of the receptacle. This sloped portion may exert a force on plug contacts in a direction of disconnection such that tabs on the plug are held in place in notches in the shield opening. In other embodiments of the present invention, this hold force may be generated in other ways.

Again, embodiments of the present invention may provide connector systems having plugs and receptacles for more than one coaxial cable. To further save space and simplify assembly, embodiments of the present invention may provide cables that include more than one coaxial cable. For example, embodiments of the present invention may provide cables that include two, three, or more coaxial cables. In one specific example, each coaxial cable may include a central conductor surrounded by an insulating jacket, the jacket surrounded by a conductive braid or other shield. These shields may be in electrical contact along all or part of the length of the cable, or they may be electrically isolated. The cables may be encased in a single insulating jacket that contacts the exposed braiding around the cables. This jacket may be shaped such that there is little or no surface deflection between adjacent coaxial cables. In another embodiment of the present invention, the braiding of the two cables may be separate. A jacket may be formed around both cables such that a narrow portion of the cable is formed between adjacent cables. This may aid in crimping the cables to a housing of the plug. It may also allow a cable with multiple coaxial cables to be separated along all or a portion of its length such that cables may be individually routed, for example to the same or different receptacles on the same or different boards.

While embodiments of the present invention are well-suited to providing plugs and receptacles for coaxial cables, other embodiments of the present invention may provide plugs and receptacles for one or more other types of cables, such as twinaxial, twisted pair, shielded twisted pair, fiber optic, single conductor, or other types of cables and combinations of these and coaxial cables.

In various embodiments of the present invention, contacts, ground contacts, metallic pieces, and other conductive portions of a coaxial plug and receptacle, such as the shell or shield, may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions may be formed using injection or other molding, 3-D printing, machining, or other manufacturing process. The nonconductive portions may be formed of silicon or silicone, rubber, hard rubber, plastic, nylon, liquid-crystal polymers (LCPs), or other nonconductive material or combination of materials.

Embodiments of the present invention may provide coaxial plugs and receptacles that may be located in and may connect to various types of devices, such as portable computing devices, tablet computers, desktop computers, laptops, all-in-one computers, cell phones, smart phones, media phones, storage devices, portable media players, navigation systems, monitors, power supplies, adapters, remote control devices, chargers, and other devices. These coaxial plugs and receptacles may provide pathways for signals that are compliant with various standards such as Universal Serial Bus (USB), a High-Definition Multimedia Interface (HDMI), Digital Visual Interface (DVI), power, Ethernet, DisplayPort, Thunderbolt, Lightning and other types of standard and non-standard interfaces that have been developed, are being developed, or will be developed in the future.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates a coaxial cable plug according to an embodiment of the present invention;

FIG. 2 illustrates a coaxial cable receptacle according to an embodiment of the present invention;

FIG. 3 illustrates a coaxial cable plug according to embodiments of the present invention;

FIG. 4 illustrates a coaxial connector receptacle according to an embodiment of the present invention;

FIG. 5 illustrates a cutaway view of a connector plug mated with a connector receptacle according to an embodiment of the present invention;

FIG. 6 illustrates the rotational freedom of a connector system according to an embodiment of the present invention;

FIG. 7 illustrates a coaxial cable plug according to an embodiment of the present invention;

FIG. 8 illustrates a coaxial connector receptacle according to an embodiment of the present invention;

FIG. 9 illustrates an initial step in the insertion of a plug into a receptacle according to an embodiment of the present invention;

FIG. 10 illustrates a following step in the insertion of a plug into a receptacle according to an embodiment of the present invention;

FIG. 11 illustrates a locked position of a plug in a receptacle according to an embodiment of the present invention;

FIG. 12 illustrates a dual coaxial cable according to an embodiment present invention; and

FIG. 13 illustrates another dual coaxial cable according to an embodiment present invention.

### DESCRIPTION OF EXEMPLARY EMBODIMENTS

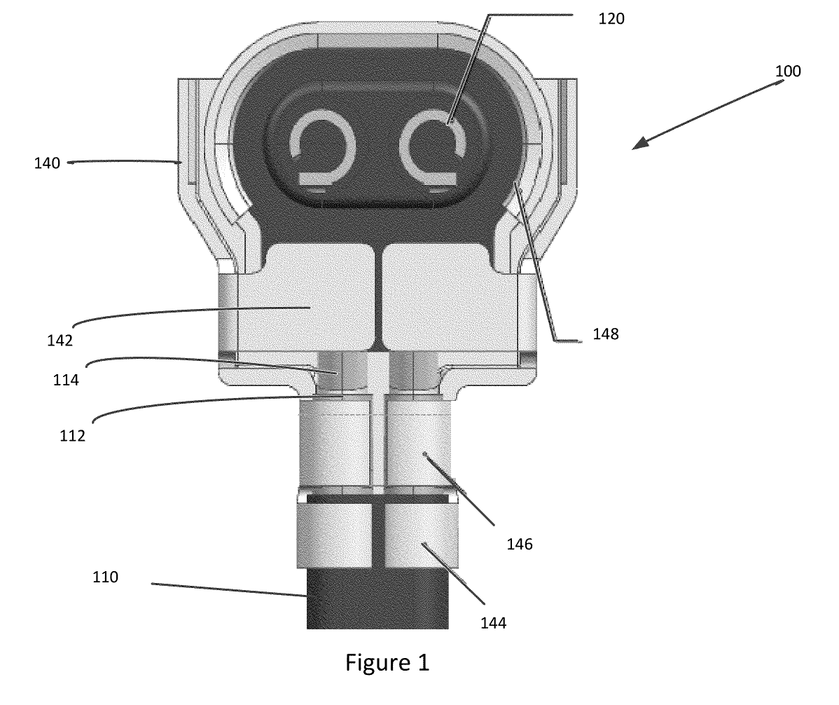

FIG. 1 illustrates a coaxial cable plug according to an embodiment of the present invention. This figure, as with the other included figures, is shown for illustrative purposes and does not limit either the possible embodiments of the present invention or the claims.

In this example, coaxial cable 110 may terminate in plug 100. Plug 100 may include a shield 140 at least partially surrounding contacts 120. Shield 140 may include ring section 148. Ring section 148 may mate with a corresponding ring on a connector receptacle when the receptacle is mated with plug 100.

Shield 140 may include tabs 142, which, along with ring section 148, may secure a plug housing in place. Shield 140 may also include crimping portions 144 to secure coaxial cable 100 in place. Shield 140 may further include crimping portion 146 to electrically connect shield 140 to braiding 112 of coaxial cable 100. Jacketed portions 114 of coaxial cable 110 may enter the body of plug 100. Conductors in coaxial cable 110 may electrically connect to contacts 120.

In this configuration, plug 100 may provide a connection for two coaxial conductors while consuming considerably less board area than two separate plugs. Specifically, shielding portions, such as shield ring portion 148, may be simplified to reduce space. Also, a space that would otherwise be needed between two plugs is no longer required with this merger.

While in this example, plug 100 may provide a connection for two coaxial cables, in other embodiments of the present invention, plug 100 may provide connections for three, four, or more coaxial cables.

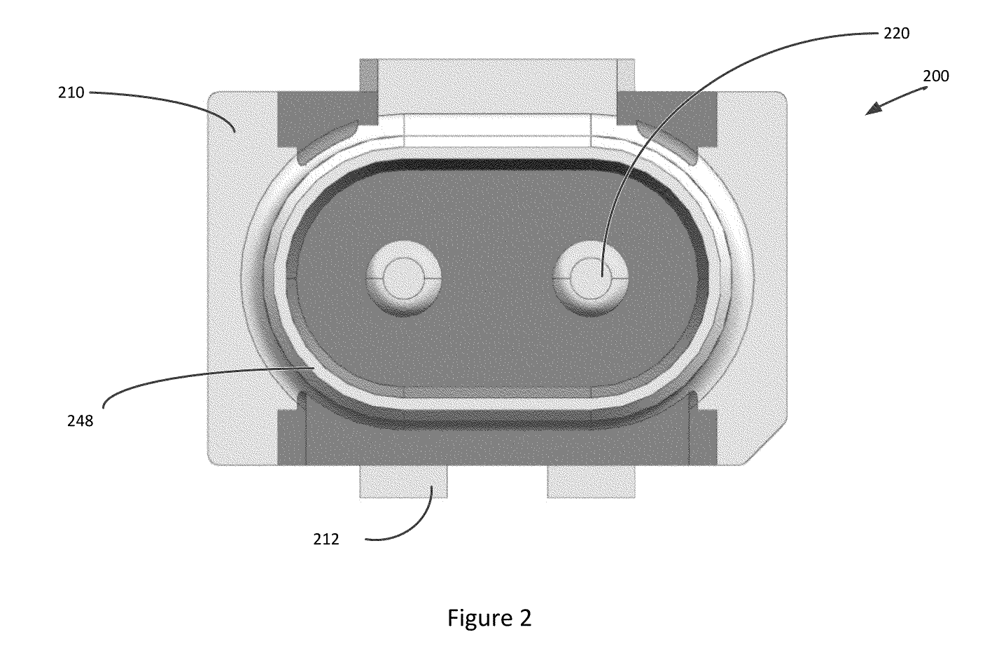

FIG. 2 illustrates a coaxial cable receptacle according to an embodiment of the present invention. Receptacle 200 may be arranged to mate with plug 100 of FIG. 1. Specifically, contacts 220 may be arranged to form electrical connections with contacts 120 in plug 100. Shield ring 248 may be arranged to engage shield ring portion 148 of plug 100. Receptacle 200 may further include a body 210 supporting contacts 212. Contacts 212 may be soldered to traces on a printed circuit board, flexible circuit board, or other appropriate structure on which receptacle 200 may reside.

Again, it may be desirable to provide a coaxial cable plug that is capable of being connected throughout an angular range. An example of one such plug is shown in the following figure.

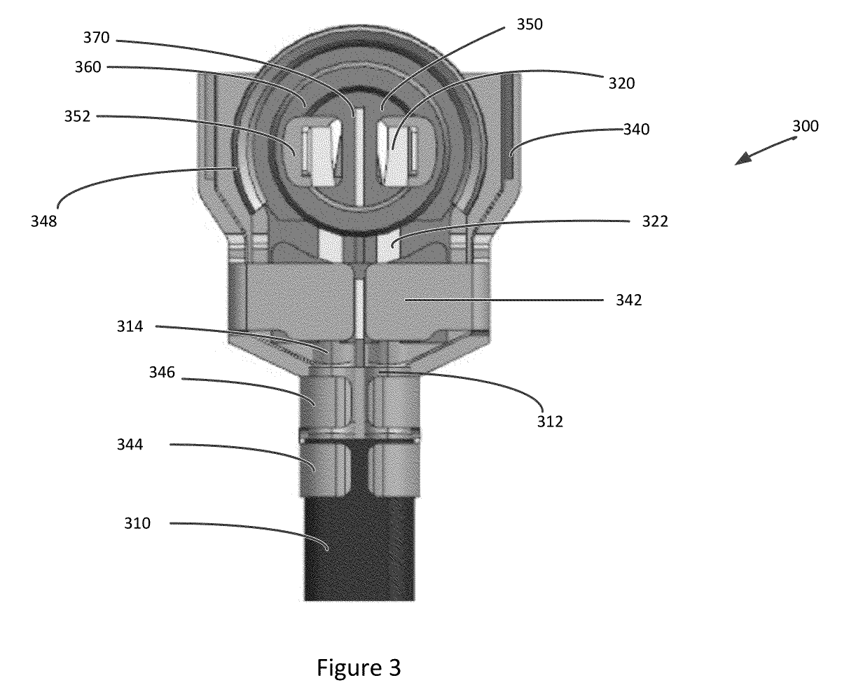

FIG. 3 illustrates a coaxial cable plug according to embodiments of the present invention. This plug 300 may accept coaxial cable 310. Plug 300 may include shield 340 having a first crimping portion 344 for securing cable 310 in place. Shield 340 may include a second crimping portion 346 for forming an electrical connection with a braiding 312 of coaxial cable 310. Shield 340 may also include tabs 342 and a ring section 348, which may hold a plug housing in place. The plug may further include this housing having a raised portion 360 defining a recess 350. Openings 352 in the recess 350 may provide space for contacts 320 to move during insertion and extraction. Specifically, contacts 220 may be arranged to deflect outward during insertion and extraction of plug 300 into and from a corresponding receptacle. That is, contacts 220 may be pre-biased inward such that they are pushed out during insertion and provide an inward force to help maintain a connection between contacts on the plug and contacts on the receptacle. Again, this arrangement may provide an absent or minimal force contacts 220 in a direction of disconnection, thereby reducing chances of an inadvertent disconnection. As before, contacts 320 may electrically connect to conductors in coaxial cable 310. Ground contacts 370 may be placed between contacts 320 to provide shielding and electrical isolation.

Plug 300 may be rotated through an angular range and still be mated with a corresponding receptacle. Once mated, plug 300 may rotate through the angular range while maintaining a connection. This angle may be defined by an opening or missing section of ring section 348. A raised portion on a corresponding connector receptacle may be arranged to fit in this opening. Plug 300 may be rotated until the raised portion on the receptacle reaches an end of the opening in ring section 348. Plug 300 may be mated with a receptacle so long as the raised portion on the receptacle is in the open portion of the ring section 348, and once mated, the plug 300 may rotate relative to the receptacle in this same angular range.

In various embodiments of the present invention, contacts 320 may be sized to limit cross talk between them. Contacts 320, the opening in ring section 348, and the corresponding raised portion on the connector receptacle may be sized to ensure that contacts 320 engage corresponding contacts on a connector receptacle throughout the range of rotation. Also, these structures may be sized to prevent contact 320 from contacting more than one contact in the connector receptacle.

Shield ring portion or section 348 and the corresponding raised section on a connector receptacle may provide a keying function ensuring that plug 300 is mated in a correct orientation with a corresponding receptacle.

While in this embodiment of the present invention, plug 300 is shown as accepting two coaxial cables, in other embodiments of the present invention, plug 300 may form connections for one, three, or more coaxial cables. Also, while contacts 320 are shown as being side-by-side, in other embodiments of the present invention, contacts 320 may be formed as concentric rings arranged to mate with concentric rings on a corresponding receptacle. This arrangement may allow plug 300 to be fully rotatable, though it may come at a cost of increase in size. Also, where plug 300 provides a connection for only one cable conductor, only one contact 320 may be needed. In this case, contact 320 may be circular, the stop may be removed, and plug 300 may be fully rotatable.

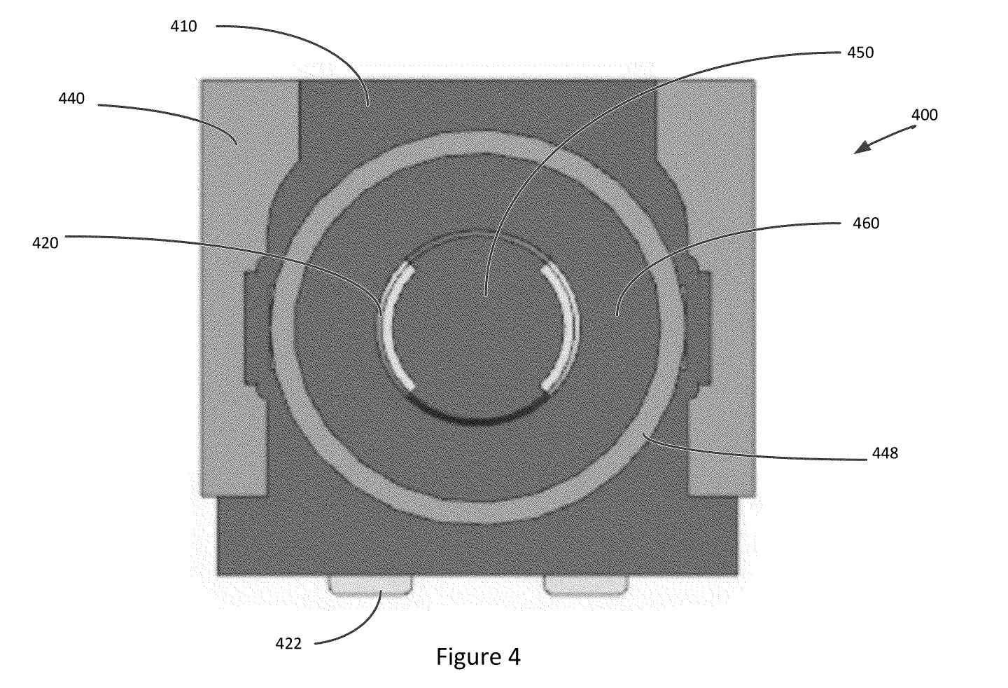

FIG. 4 illustrates a coaxial connector receptacle according to an embodiment of the present invention. Connector receptacle 400 may include housing 410 supporting a raised portion 450. Raised portion 450 may be arranged to fit in recess 350 of plug 300. Contacts 420 may be arranged to mate with contacts 320 in plug 300. Ring 448 may be arranged to engage shield ring section 348 on plug 300. Housing 410 may support shielding 440 and have a number of contacts 422. Contacts 422 may electrically connect to contacts 420 and may be arranged to be soldered to a printed circuit board, flexible circuit board, or other appropriate substrate.

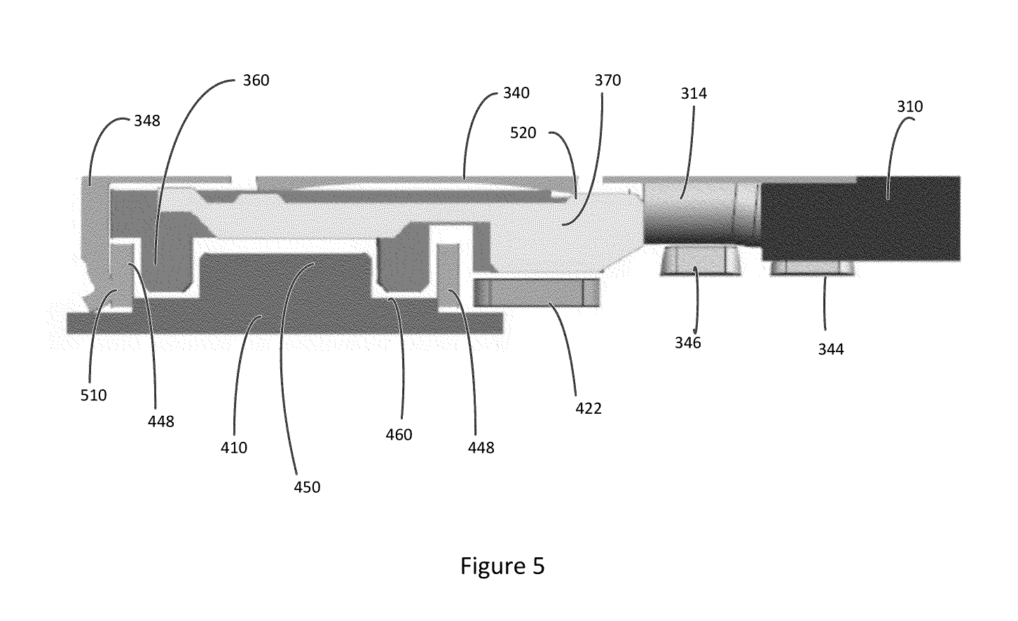

FIG. 5 illustrates a cutaway view of a connector plug mated with a connector receptacle according to an embodiment of the present invention. As before, the plug may accept coaxial cable 310 and may include crimping portions 344 to secure cable 310 and crimping portion 346 to electrically connect to shield or braiding 314. Center ground plane 370 may electrically connect to shield 340 to points 520 and to braiding 314.

The receptacle may include housing 410 having a raised portion 450 arranged to fit in a recessed defined by raised portion 360 on the plug. Shield ring 348 may be arranged to engage ring 448 on the receptacle at points 510. Specifically, ring 448 may have an indentation or slot at point 510 to accept a protrusion on ring section 348.

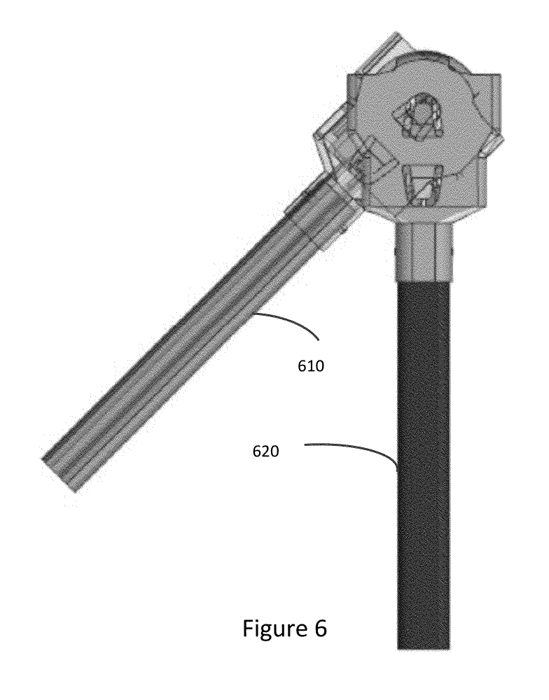

FIG. 6 illustrates the rotational freedom of a connector system according to an embodiment of the present invention. Specifically, a coaxial cable plug may rotate through positions 620 and 610 while making a connection, and while being connected together. Again, this angular range may be defined by the opening in ring section 148 on the plug 400 and the raised portion on the receptacle 300. In this example, the direction of insertion of the plug is orthogonal to the plane of the figure. A connection may be made so long as the cable is in the permitted angular range and in a plane orthogonal to the direction of insertion.

In the above embodiments of the present invention, an insertion force may be needed to fit ring 348 of insert 300 over ring 448 of receptacle 400 such that a lip on ring 348 engages notch or slot 510 on ring 448, and such that plug contacts 220 engage corresponding receptacle contacts on raised portion 450 of receptacle 400. Generally, increasing a hold or retention force of the above connector system requires increasing this insertion force. However, such forces may lead to accidental damage of portions of the connector system. Accordingly, embodiments of the present invention may provide connector systems where the insertion force is decoupled, or made independent of, the retention force. An example of such a connector system is shown in the following figures.

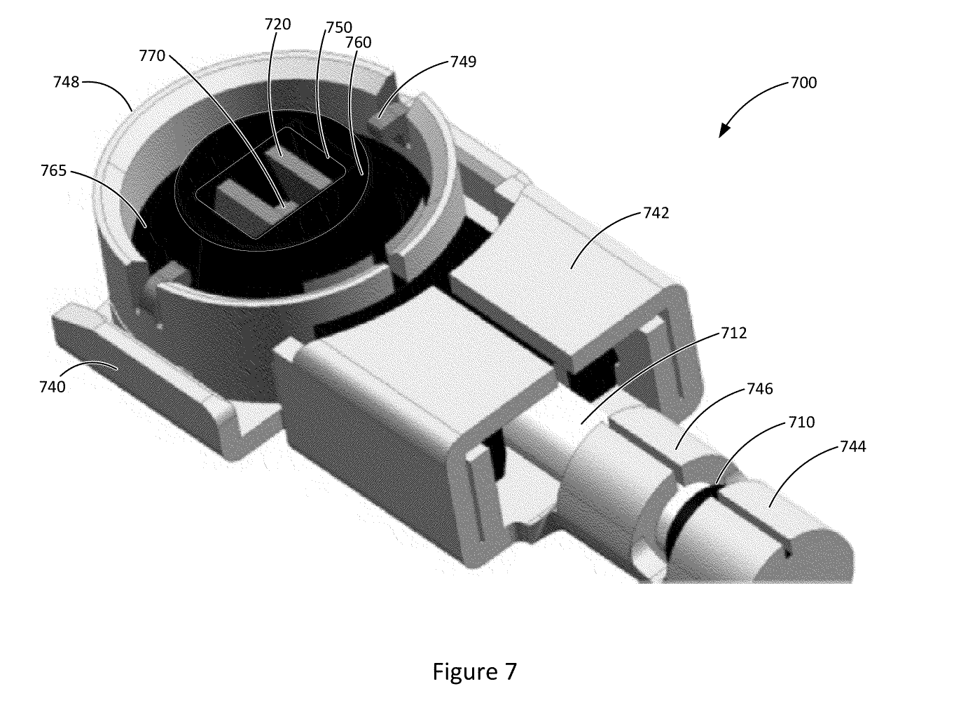

FIG. 7 illustrates a coaxial cable plug according to an embodiment of the present invention. Plug 700 may accept coaxial cable 710. Coaxial cable 710 may include one, two, three, or more coaxial cable conductors. Plug 700 may include shield 740 having a first crimping portion 744 for securing cable 710 in place. Shield 740 may include a second crimping portion 746 for forming an electrical connection between shield 740 and braiding 712 of coaxial cable 710. Shield 740 may also include tabs 742 and a ring section 748, which may engage a corresponding ring on a connector receptacle. The plug may further include a housing having raised portion 760 defining inside recess 750 and outside recess 765 that may accept the ring on the connector receptacle. Recess 750 may provide an opening for contacts 720 to move during insertion and extraction of plug 700 into and from a corresponding receptacle. Specifically, contacts 720 may be arranged to deflect outward during insertion and extraction of plug 700 to and from a corresponding receptacle. That is, contacts 720 may be pre-biased inward such that they are pushed outward during insertion and provide an inward force to help maintain connection between contacts on the plug and contacts on the receptacle.

As before, contacts 720 may electrically connect to conductors in coaxial cable 710. In this example, two contacts 720 are shown and may be electrically connected to two coaxial conductors in coaxial cable 710. In other embodiments of the present invention, plug 700 may include one, three, or more such contacts, which may be electrically connected to conductors in coaxial cable 710. Ground contact 770 may be placed between contacts 720 to provide shielding and electrical isolation.

Shield 740 may further include tabs 749. Tabs 749 may engage openings in a corresponding ring in the connector receptacle during insertion. Tabs 749 may provide a locking mechanism to secure plug 700 in place in a connector receptacle. An example of such a connector receptacle is shown in the following figure.

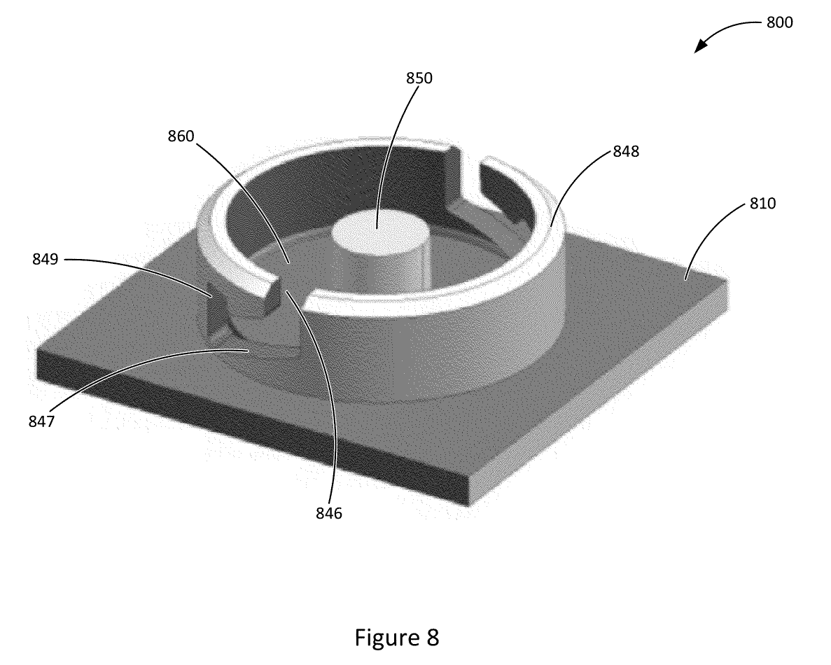

FIG. 8 illustrates a coaxial connector receptacle according to an embodiment of the present invention. Connector receptacle 800 may include a raised portion 850 supporting one or more contacts. Connector receptacle 800 may further include shield portion 848. Shield portion 848 may include opening 846, which may lead to ramp 847 and notch 849. During insertion of a plug, such as plug 700, tabs 749 may engage opening 846. During further insertion, tabs 749 may travel along ramp 847 while plug 700 is appropriately rotated. When tabs 749 reach notch 849, plug 700 may be locked in receptacle 800. To maintain tabs 749 in notch 849, and upward force may be applied to plug 700. This force may be generated by sloped edges on either or both shield portions 748 and 848. Force may also be generated by sloped sides of raised portion 850, which may act to push contacts 720, and therefore plug 700, in a disconnection direction. Further illustration of an insertion process is shown in the following figures.

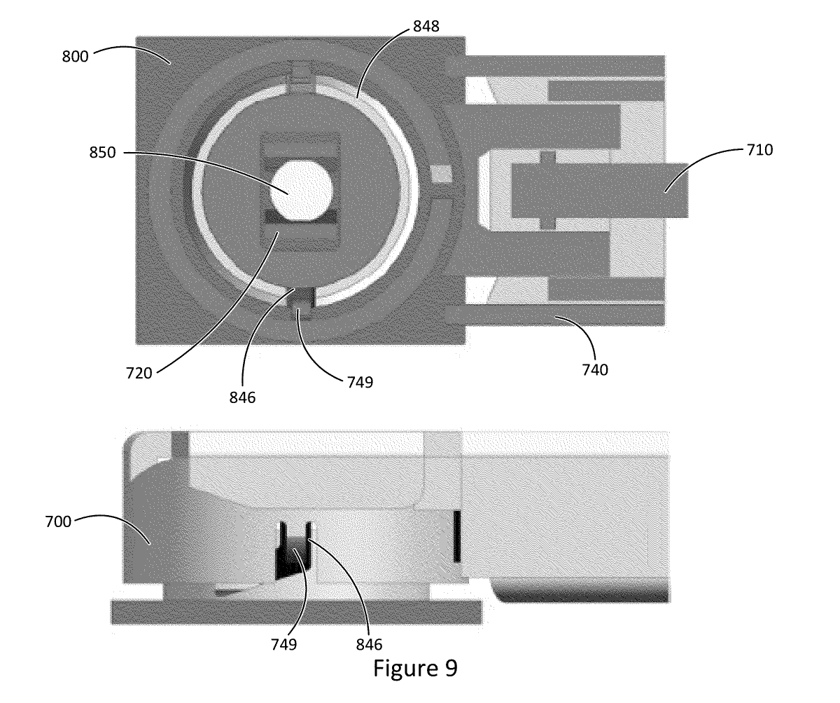

FIG. 9 illustrates an initial step in the insertion of a plug into a receptacle according to an embodiment of the present invention. In this example, plug 700 may be inserted into receptacle 800. Specifically, plug tabs 749 of plug housing 740 may be aligned with opening 846 in receptacle shield portion 848. At this point, plug contacts 720 may engage contacts on raised portion 850 of receptacle 800.

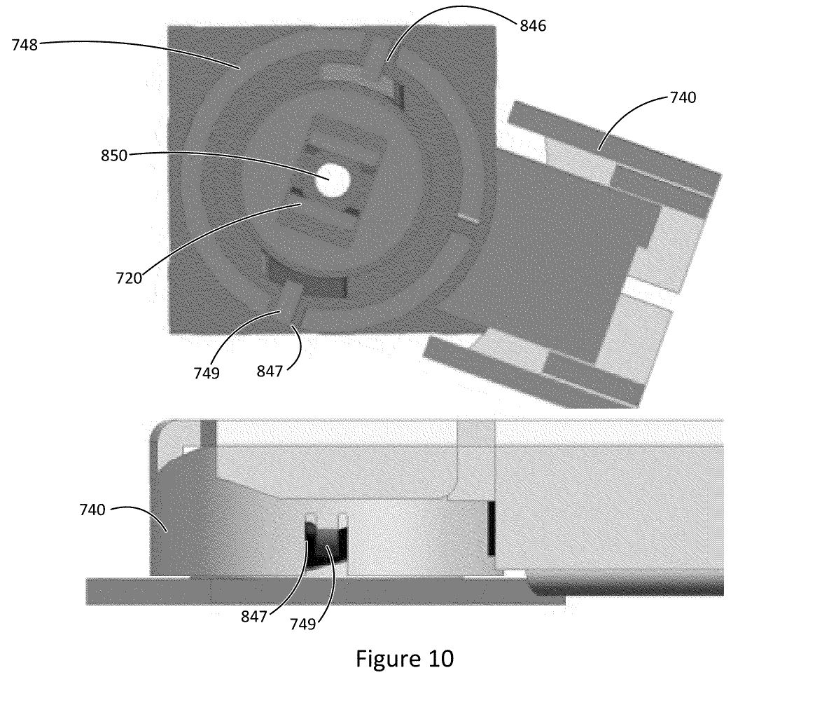

FIG. 10 illustrates a following step in the insertion of a plug into a receptacle according to an embodiment of the present invention. In this example, housing 740 may be rotated such that plug tab 749 of housing 740 travels along ramp 847.

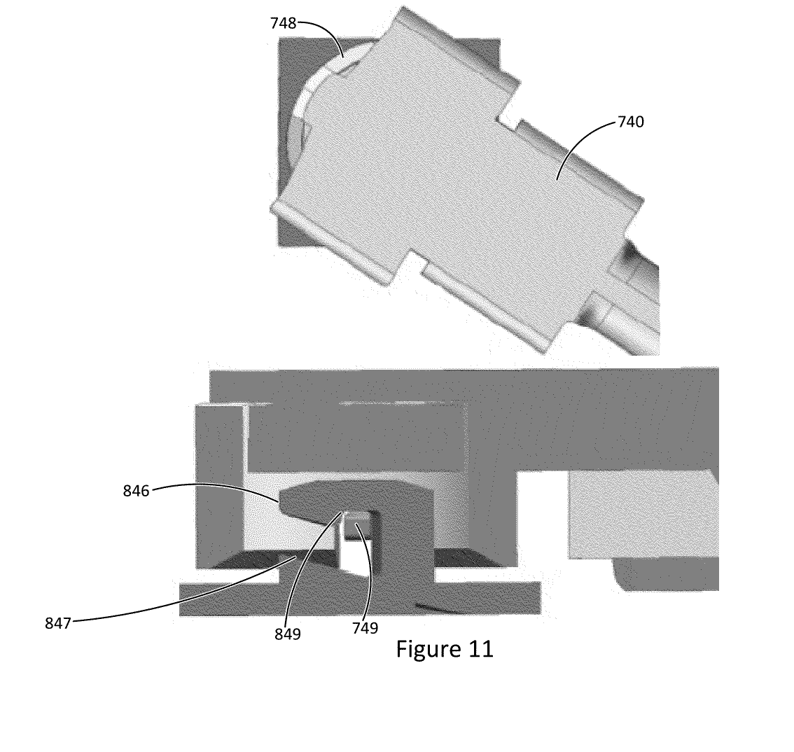

FIG. 11 illustrates a locked position of a plug in a receptacle according to an embodiment of the present invention. In this example, housing 740 has been rotated sufficiently such that plug 749 has reached notch 849. At this point, upward forces, as previously described, may hold tabs 749 in place in notch 849.

In these embodiments of the present invention, the required forces to complete an insertion may be adjusted by adjusting a slope of ramp 847. For example, a steeper ramp may require more force in the direction of insertion while requiring a lower rotational force. A shallower ramp may require less force in a direction of insertion, but may require more rotational force to complete the rotation. In various embodiments of the present invention, the change in required rotational force may be negligible, absent, or it may be reversed such that a shallower ramp may require a lesser rotational force.

In this embodiment of the present invention, housing 740 may be rotated to a particular angle when locked. This angle may be further identified by guide marks or features on a portion of the connector receptacle, plug, board, or combination thereof. During assembly, this may provide a simple way to visually inspect that an insertion has been properly made.

The locked position provided by these embodiments of the present invention may provide a connector system that is more reliable and less likely to inadvertently disconnect when subjected to sudden forces.

Again, embodiments of the present invention may accept cables having two or more individual coaxial cables. Examples of cables according to embodiments of the present invention are shown in the following figures.

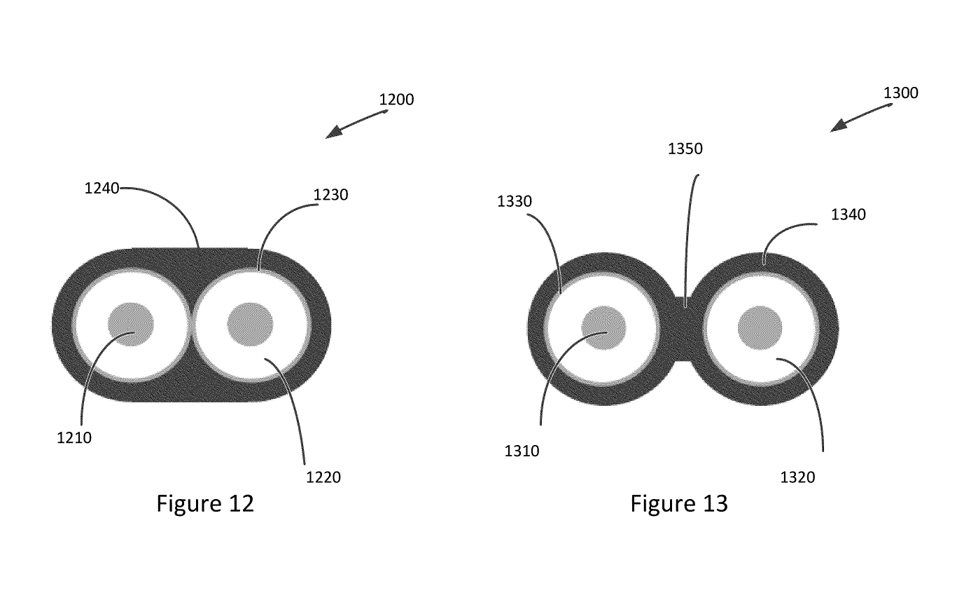

FIG. 12 illustrates a dual coaxial cable according to an embodiment present invention. In this example cable 1200 may include two conductors 1210. Each conductor may be surrounded by and insulating jacket 1220. Each insulating jacket 1220 may be surrounded by a shield or braiding 1230. The shields or braiding 1230 may be in electrical contact with each other for all or part of the length of the cable, they may be electrically separated from each other, or they may be formed as a single unit. Jacket 1240 may surround both conductors and be in contact with exposed surfaces of shielding or braiding 1230. Jacket 1240 may be arranged such that it is substantially smooth in the region between conductors 1210.

FIG. 13 illustrates another dual coaxial cable according to an embodiment of the present invention. In this example, cable 1300 may include two conductors 1310. Each conductor 1310 may be surrounded by insulating jackets 1320. Insulating jacket 1320 may be surrounded by shielding or braiding 1340. The two conductors may be surrounded by jacket 1350. Jacket 1350 may electrically isolate shields or braids 1340 from each other. Jacket 1350 may be substantially narrowed in a region between the two conductors. This may allow the two conductors to be separated or pulled apart along part or all of the cable 1300 as needed. This may allow the conductors 1310 to be individually routed to separate destinations. While in these examples two coaxial cables are shown, in other embodiments of the present invention, fewer or more than two coaxial cables may be combined into a single cable. For example, one, three, four, or more coaxial cables may be included in a single cable.

While embodiments of the present invention are well-suited to providing plugs and receptacles for coaxial cables, other embodiments of the present invention may provide plugs and receptacles for one or more other types of cables, such as twinaxial, twisted pair, shielded twisted pair, fiber optic, single conductor, or other types of cables and combinations of these and coaxial cables.

In various embodiments of the present invention, contacts, ground contacts, metallic pieces, and other conductive portions of a coaxial plug and receptacle, such as the shell or shield, may be formed by stamping, metal-injection molding, machining, micro-machining, 3-D printing, or other manufacturing process. The conductive portions may be formed of stainless steel, steel, copper, copper titanium, phosphor bronze, or other material or combination of materials. They may be plated or coated with nickel, gold, or other material. The nonconductive portions may be formed using injection or other molding, 3-D printing, machining, or other manufacturing process. The nonconductive portions may be formed of silicon or silicone, rubber, hard rubber, plastic, nylon, liquid-crystal polymers (LCPs), or other nonconductive material or combination of materials.

Embodiments of the present invention may provide coaxial plugs and receptacles that may be located in and may connect to various types of devices, such as portable computing devices, tablet computers, desktop computers, laptops, all-in-one computers, cell phones, smart phones, media phones, storage devices, portable media players, navigation systems, monitors, power supplies, adapters, remote control devices, chargers, and other devices. These coaxial plugs and receptacles may provide pathways for signals that are compliant with various standards such as Universal Serial Bus (USB), a High-Definition Multimedia Interface (HDMI), Digital Visual Interface (DVI), power, Ethernet, DisplayPort, Thunderbolt, Lightning and other types of standard and non-standard interfaces that have been developed, are being developed, or will be developed in the future.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A coaxial cable assembly comprising:
a coaxial cable having a first end and a second end; and
a plug at a first end, wherein the coaxial cable enters the plug in a first direction, and wherein the plug is arranged to mate with a receptacle in a second direction, the first direction at least substantially orthogonal to the second direction,
wherein when the plug may be mated with the receptacle when the plug and receptacle are aligned in the second direction and the cable is in at least part of a first plane that is at least substantially orthogonal to the second direction.

2. The coaxial cable assembly of claim 1 wherein a single coaxial cable enters the plug in the first direction and the plug may be mated with the receptacle when the plug and receptacle are aligned in the second direction and the cable is in the first plane.

3. The coaxial cable assembly of claim 1 wherein a dual coaxial cable enters the plug in the first direction and the plug may be mated with the receptacle when the plug and receptacle are aligned in the second direction and the cable is in at least a portion of the first plane.

4. The coaxial cable assembly of claim 3 wherein when the plug is inserted into the receptacle, the plug may rotate such that the cable may sweep through a first angle.

5. The coaxial cable assembly of claim 4 wherein the first angle is defined by a stop feature on the plug.

6. The coaxial cable assembly of claim 5 wherein the stop feature on the plug comprises a shield having a portion formed as a section of a ring.

7. The coaxial cable assembly of claim 6 wherein the shield portion formed as a section of a ring has an open portion, the open portion arranged to accept a raised portion on the receptacle when the plug is mated with the receptacle.

8. The coaxial cable assembly of claim 7 further comprising a second plug at a second end of the cable.

9. The coaxial cable assembly of claim 4 wherein the coaxial cable comprises:
a first conductor surrounded by a first insulating layer, the first insulating layer surrounded by a first shield;
a second conductor surrounded by a second insulating layer, the second insulating layer surrounded by a second shield; and
a third insulating layer around the first shield and the second shield and adjacent to all exposed surfaces of the first shield and the second shield such that a region between the first conductor and the second conductor is substantially smooth.

10. The coaxial cable assembly of claim 4 wherein the coaxial cable comprises:
a first conductor surrounded by a first insulating layer, the first insulating layer surrounded by a first shield;
a second conductor surrounded by a second insulating layer, the second insulating layer surrounded by a second shield; and
a third insulating layer around the first shield and the second shield and adjacent to all exposed surfaces of the first shield and the second shield such that a region between the first conductor and the second conductor is substantially narrowed.

11. The coaxial cable assembly of claim 5 wherein the stop limits rotation of the plug such that a contact in the plug may not contact more than one contact in the receptacle.

12. The coaxial cable assembly of claim 5 wherein the stop limits rotation of the plug such that a contact in the plug does not lose contact with a corresponding contact in the receptacle.

13. The coaxial cable assembly of claim 1 wherein the plug further comprises a shield having tabs, the tabs arranged to fit in openings in a shield of the receptacle.

14. The coaxial cable assembly of claim 13 wherein the openings in the shield of the receptacle each comprise a ramp and a notch, wherein during insertion, the plug tabs travel along the ramps as the plug housing rotates until the tabs reach the notch.

15. A coaxial connector plug comprising:
a shield;
a housing having a raised portion, the raised portion defining a recess in a center of the raised portion;
first and second openings in the recess in the housing;
a first contact in the first opening and a second contact in the second opening;
a ground plane between the first and second contact;
a ring section around the first and second contacts, the ring section having an open section, wherein the plug may rotate relative to the receptacle through an angle defined by the opening in the ring section.

16. The coaxial connector plug of claim 15 wherein recess in the housing is arranged to accept a raised portion on a receptacle during insertion.

17. The coaxial connector plug of claim 15 wherein the first contact is coupled to a first coaxial conductor attached to the plug and the second contact is coupled to a second coaxial conductor attached to the plug.

18. The coaxial connector plug of claim 17 wherein the first coaxial conductor and the second coaxial conductor are part of a coaxial cable.

19. The coaxial connector plug of claim 18 wherein the coaxial cable comprises:
a first conductor surrounded by a first insulating layer, the first insulating layer surrounded by a first shield;
a second conductor surrounded by a second insulating layer, the second insulating layer surrounded by a second shield; and
a third insulating layer around the first shield and the second shield and adjacent to all exposed surfaces of the first shield and the second shield such that a region between the first conductor and the second conductor is substantially smooth.

20. The coaxial connector plug of claim 18 wherein the coaxial cable comprises:
a first conductor surrounded by a first insulating layer, the first insulating layer surrounded by a first shield;
a second conductor surrounded by a second insulating layer, the second insulating layer surrounded by a second shield; and
a third insulating layer around the first shield and the second shield and adjacent to all exposed surfaces of the first shield and the second shield such that a region between the first conductor and the second conductor is substantially narrowed.

21. The coaxial connector plug of claim 15 wherein the opening in the ring section is arranged to accept a second raised portion on the connector receptacle.

22. The coaxial connector plug of claim 21 wherein the ring section mates with a ring on the receptacle to hold the plug in place relative to the receptacle.
